(19) United States
(12) Patent Application Publication
(10) Pub. No.: US 2005/0289604 A1
(43) Pub. Date: Dec. 29, 2005

(54) System and method for receiving cable television via cellular telephone frequencies

(76) Inventor: Stephen D. Byers, Los Angeles, CA (US)

Correspondence Address: STEPHEN BYERS, 725 S. FIGUEROA ST., SUITE 2800, LOS ANGELES, CA, 90017, US

(21) Appl. No.: 10/867,358

(22) Filed: Jun. 14, 2004

(51) Int. Cl. H04N 7/16; H04N 7/20

(52) U.S. Cl. 725/62; 725/63

(57) ABSTRACT

A system for providing cable television comprises a cable provider providing television programming and a display to display the television programming, wherein the display receives the television programming via radio waves having a frequency at which cellular telephones operate.

### I. FIELD OF INVENTION

The present invention is directed generally to a system and method of providing satellite television to mobile devices via the radio frequencies generally used by cell phones.

### II. BACKGROUND

Statistics show that nearly one in three individuals in the U.S. owns a cell phone. As use grows, so does the number of cell sites that provide service for the cell phones. Across the U.S., it is a rare place where one cannot get service due to a lack of cell sites. Also as use grows, the cost to operate a cell phone, in terms of a monthly rate for phone usage (normally expressed as a given number of airtime minutes) is decreasing. Thus, people are finding it cheaper and more convenient to user their cell phone constantly. Additionally, as technology improves, and particularly as microprocessing speeds improve exponentially according to Moore's Law, the ability of the cell phone to do things other than allow a person to talk on the phone is increasing as well. Currently, one can take pictures with their phone and some can even take very short grainy videos and then one can send those pictures or video to other cell phones via the same frequencies used by the cell phone. In the U.S., current Global System for Mobile communication (GSM) phones operate in the 1900 MHz band (1.9 GHz) while in Europe the GSM phones operate in the 900 MHz and 1800 MHz band.

The use of cable television is also continually on the rise. Cable television is distinguished here from broadcast television. Broadcast television is television which is broadcast from a programming station via tall radio towers. However, the limitation with broadcast television is that the radio waves flow from the radio antenna in a straight line, and thus you must be in the “line of sight” of the antenna. Thus, in most areas, especially metropolitan areas where there are a lot of buildings, a typical TV cannot receive many broadcast channels. Additionally, even the broadcast channels that a user may receive, the image may be grainy and unclear. Instead, most people subscribe to cable television, which because of the technology utilized, are clear and ungrainy.

There are two different ways to currently receive cable television. The first is via cable that is laid underground, or above ground in some cases, which run from a cable provider (for instance Adelphia in Southern California) which receives programming from many different programming sources (for instance HBO, ESPN, etc.). The second is via satellite. In this second case, a programming source sends its programming, normally via satellite, to a cable provider. The cable provider compiles the programming and sends it via geosynchronous satellites to a subscriber's home. Typically, in satellite systems, the programming content is compressed by the cable provider, typically using the MPEG-2 compression standard. This compression standard can reduce the 270 Mbps stream to about 5 or 10 Mbps. A typical satellite can transmit about 200 channels whereas without the compression, it could transmit about 30 channels. Early satellite television was broadcast in the 3.4 GHz to 7 GHz range. Digital broadcast satellites transmit programming at a frequency in the 12 GHz to 14 GHz range.

This invention seeks to provide cable television programming to mobile viewers at a frequency which can operate on current or future cellular telephone networks at a frequency utilized by cellular telephones.

### III. BRIEF DESCRIPTION OF THE DRAWINGS

FIG. 1 is a depiction of an embodiment of the invention;

FIG. 2 is a flowchart diagram of an embodiment of the invention.

FIG. 3 is a flowchart diagram of an embodiment of the invention.

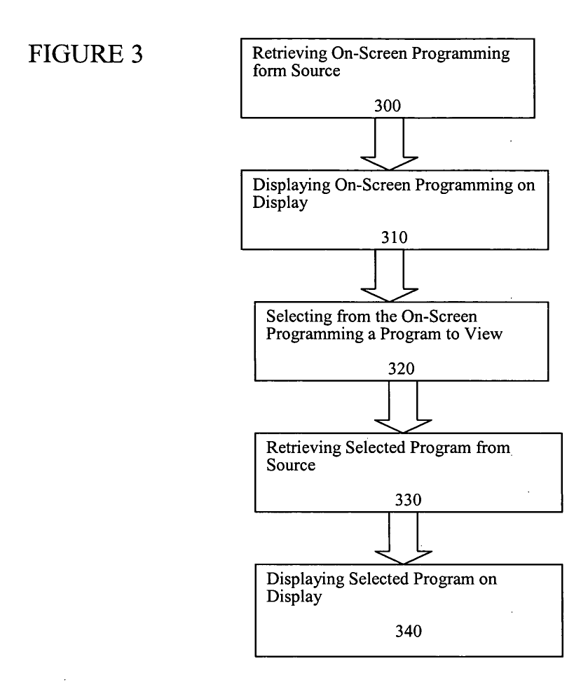

FIG. 4 is a depiction of an apparatus according to an embodiment of the present invention.

FIG. 5 is a depiction of another apparatus according to an embodiment of the present invention

### IV. DETAILED DESCRIPTION

Embodiments of the present invention are directed to a system, method and apparatus of providing a cable television program to a mobile device using the frequency used by mobile phones. Cable television here refers to programming that is sent by a single cable provider, for instance Adelphia in southern California, which is made up of programming (such as “60 Minutes”, “Sopranos”, and local news broadcasts) from a plurality of program sources, for instance HBO, FOX, ABC, and the History Channel. Cable television is traditionally provided to the subscriber via a cable or via a satellite network (as DirecTV does). The frequency used by cellular telephones refers to those frequencies which cellular telephones use to send and receive communication signals (such as two people talking). In the U.S., current 3^{rd} generation cellular telephones operate on a GSM network that uses frequencies about 1.9 GHz (1900 MHz). The cell sites which provide mobile phones with service are numerous and located all along geographically desirable areas such as major highways and major city streets. Current satellite television such as that provided by DirecTV requires that a satellite dish be pointed in an exact location in the sky at all times to receive the broadcast, and it is not convenient for mobile users who are constantly changing their direction to receive a broadcast directly from the satellite. Furthermore, satellite dishes are bulky and unsightly. Most people would not want to install a satellite dish on their car, nor would such antennas be appropriate for other mobile displays such as cell phones and personal data assistants. Thus it would be useful for users to receive cable television programming which can take advantage of the large network of cellular service cell sites by sending and receiving the cable television programming at a frequency used by cellular telephones.

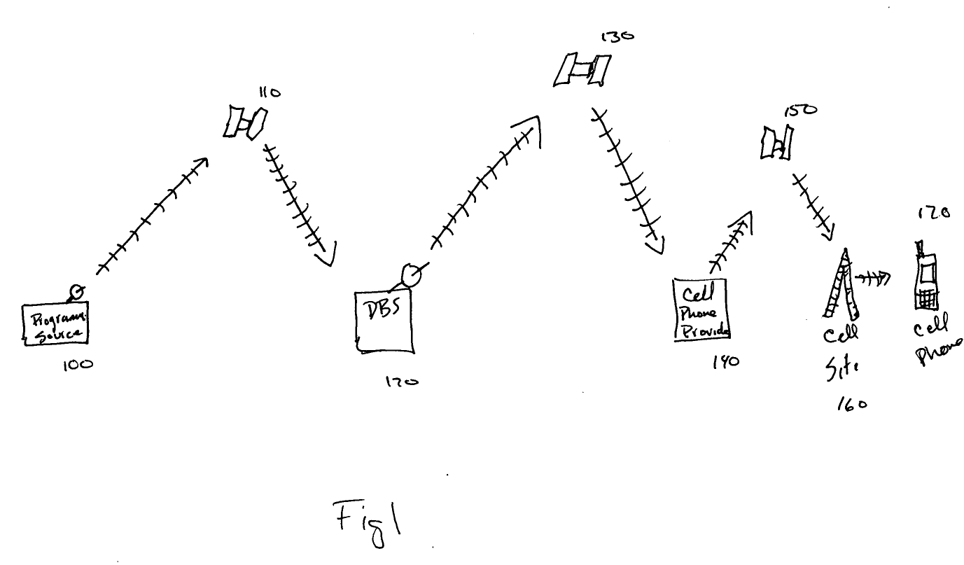

FIG. 1 depicts an embodiment of the system of the present invention. A programming source 100, for example HBO, sends its programming, for instance an episode of “The Sopranos,” to a cable provider 120, for instance Adelphia or DirecTV. It may do this via a satellite 110 or by a series of cables (not pictured). The broadcast provider 120 then sends the programming to a cellular telephone service provider (CTSP) 140, for example AT&T Wireless or Verizon. The broadcast provider may provide the programming to the CTSP 140 via a satellite 130 or a series of cables (not pictured). The CTSP 140 then sends the programming to a subscriber's display device 170 using the frequencies used by cellular telephones.

The subscriber's display device may be a mobile phone, a Personal Data Assistant (PDA), or another display device, for instance, a monitor located in a vehicle, a cab, a bus, a train or another form of transportation. In one embodiment of the present invention, the programming would be sent to the subscriber's display device utilizing the frequency of about 1.9 GHz which is the current frequency of GSM (global system for mobile communications, formerly known as “Groupe Special Mobile”) phones in America. In another embodiment, the programming could be sent to the subscriber's display device at about 900 MHz or 1800 MHz which are both frequencies utilized by GSM phones in Europe. As cellular technology becomes more powerful and changes, the frequencies which cellular phones may operate on, may change as well. This invention is intended to operate on all frequencies which cellular phones now, or may in the future, operate.

A normally GSM phone may be able to receive data at speeds of 14.4 Kbps, however, newer technologies that allow for packet-switching are allowing for faster and faster data transfer speeds. A GSM extension called High-Speed Circuit-Switched Data (HSCSD) allows for data transmission speeds of up to 43.3 Kbps. A GSM extension called GPRS allows packet switched data transmission by allocating unused cell bandwidth to transmit data. The theoretical limit for data switched using GPRS is approximately 170 Kbps, whereas. One of the newest mobile phone technologies titled EDGE (Enhanced Data Rates for Global Evolution) can carry data speeds up to 473 Kbps. When sending large pieces of data, such as a television program, it will likely be beneficial to employ packet-switching technology like EDGE or other similar programs.

In another embodiment of the present invention, the cable provider could send the programming directly to the subscriber's display device on a frequency at which cellular phones operate without sending the programming to the CTSP. However, this would like require the cable provider to either build their own cell sites, or lease cell sites from a CTSP.

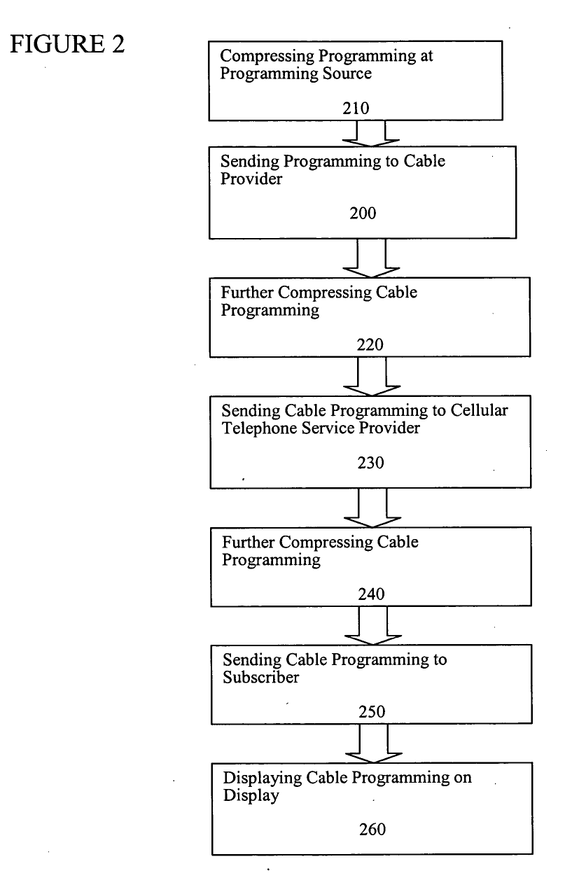

FIG. 2 is a flowchart diagram describing a method of the present invention. The programming sources 100 send programming to the cable provider 130 at step 200. The programming may first be compressed 210 using a video compression technology like those developed by the Motion Picture Experts Group (MPEG). For example MPEG-2 compression technology may be used. The compressed video signals may be sent to cable provider. At the cable provider, the cable provider may compress 220 the entirety of the cable programming which is made up of a plurality of television shows sent by the programming sources, and send 230 the compressed cable programming to the CTSP. The CTSP may then further compress 240 the cable programming before sending the cable programming to a subscriber's display device using frequencies at which cellular phones operate 250. The display device then receives the programming, and displays the programming 260.

In an embodiment of the present invention, an entire cable programming (a signal encompassing all the television shows currently available) may be sent to the display. In another embodiment, only one program is sent to the display after a user has requested that program.

In an embodiment of the invention the, the display device may convert the compression signal into an analog NTSC format. In another embodiment, the display device may have a player which plays files in the format in which the signal is compressed, for instance an MPEG or REAL media player.

In an embodiment of the present invention, the display device may play the programming as a streaming video signal, such that the programming is playing in real time, or near real time. In another embodiment, the programming may be downloaded to a memory which is electrically coupled to the display and then the programming files are executed from the memory.

In an embodiment of the present invention, the signal is encrypted first before it is sent to the display. In this embodiment, the display device then must also decrypt the signal before it can be displayed. Encryption is often used by satellite cable providers to prevent unauthorized interception of the television programming.

In one embodiment of the present invention, the subscriber may pay a monthly fee to have access to the cable programming. In another embodiment, the subscriber may pay a pay-per-view charge.

The display may be of a any type of display that is capable of displaying a video signal. For instance, the display may be set to display a video signal in NTSC. The display may also be set to display the video in an MPEG format, REAL format, Windows Media format, or any other format capable of displaying video.

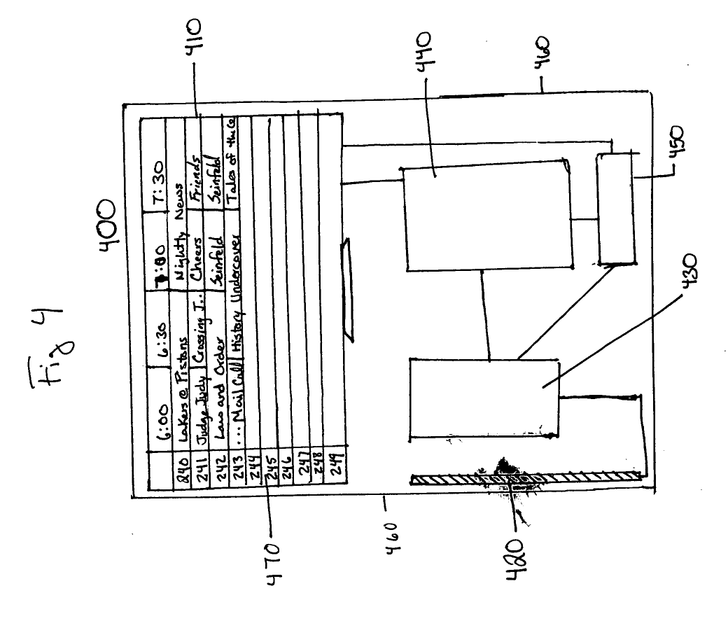

FIG. 4 depicts one embodiment of the display where the display is a monitor 400 that is installed in a vehicle. The monitor 400 may be of the kind that is commonly inserted into a headrest or a sun visor. The monitor 400 may also be of the flip down variety in which the screen flips down from an overhead compartment or housing which is installed flush with the ceiling of the vehicle or is embedded in the ceiling of the vehicle. In another embodiment, the monitor 400 may be of the kind that flips-up from a head unit installed where one would likely find the radio, such as the displays that currently offered by Alpine. Practically speaking, any type of monitor that may display video signals, regardless of where it is mounted, may be used as the display in the current invention.

Electrically coupled to the monitor 400 is an antenna 420 used to receive signals at a frequency at which cellular telephones receive signals. In the U.S., currently GSM cell phones work at a frequency of 1.9 GHz. The antenna 420 may be mounted to the display 410 itself, or in the housing 460 of the display. In another embodiment, the antenna 420 may be mounted at another location in the car and simply electrically coupled to the monitor 400 and the display 410. In another embodiment, the antenna 420 may be located on an external surface of the car (for instance, the roof, the trunk, extending from the hood, etc.). In another embodiment, the existing radio antenna may be utilized to receive the signals and direct those signals to the display 410. The antenna 420 used in this invention does not require a parabolic dish, nor does it need to be “aimed” to a certain location in the sky to receive those broadcast signals, unlike other antennas used to receive cable programming like that sent by DirecTV. Instead the antenna may be small and not “aimed” anywhere in particular.

In an embodiment of the invention, electronically coupled to the display 410 and the antenna 420 is a converter 430 that is capable of converting the signals received by the antenna 420 to a form which is usable by the display 410 to present the moving pictures of a television show. The converter 430 may convert the signals received by the antenna 420 to an NTSC form, a REAL player form, a Windows Media form, or any other form in which the display 410 may present the media. In an embodiment of the present invention, the converter 430 may also decompress the signals received by the antenna 420 before the converter 430 sends the signal to the display 410. In another embodiment of the present invention, the converter 430 may also decrypt an encrypted broadcast.

In another embodiment, the display 410 may be electrically coupled to a memory device 440 that is capable of electronically storing the television programming. In one embodiment of the present invention, the antenna 420 will receive a signal which will then pass to the converter 430 which will convert the signal into a useable format, for instance, compiling the data in the signal into a single file. The file may then be stored in the memory 440. This operation is similar to downloading a file to one's computer from the Internet, except that instead of utilizing a land based phone line, a T1 connection, a T3 connection, or a wireless Internet connection working at 2.4 GHz, etc., one is downloading the file from a cellular telephone connection which is employing the wide array of cellular telephone transmission towers (cell sites) that dot the city streets and countryside. In much the same fashion as downloading a file from the Internet, once the file has been downloaded (or in some cases, as one is still downloading the file), the user may open and the file and view the contents thereof on the display 410. In the case of the present invention, the file contains a television program.

The monitor 400 may further include a user interface and control circuitry 450 that is coupled to the various elements of the monitor 410, 430, etc. so that a user may control the various operations of the monitor 400 such as choosing a program to view, etc.

In an embodiment of the present invention, the monitor 400 is adapted to retrieve and display on-screen programming 470 which displays the cable programming available. For instance, the on-screen programming 470 may show that the television channel TNT is displaying the Los Angeles Lakers basketball game at 6:00 on Sunday and that at the same time ABC is showing “60 Minutes” and HBO is showing “Shrek.” The on-screen programming may also display programming that is available in a format known as “on-demand” programming, On-demand programming means that a number of shows are available from a single programming source. For instance channel 247 may be the channel given to Comedy Central and Comedy Central may offer a user the ability to watch episodes of “South Park,” “Reno 911,” “Kings of Comedy”, or any of the other programming at any given time by use of “on-demand” programming.

In an embodiment of the present invention in which a monitor 400 is adapted to display on-screen programming 470, the system may operate thusly: The monitor 400 may be adapted to retrieve the on-screen programming 470 from its source (for instance, a cable provider such as Adelphia, or a cellular service provider such as AT&T) when the monitor 400 is powered on. In another embodiment, the monitor 400 may be adapted to retrieve the on-screen programming 470 at a predetermined time, for instance 3:00 a.m. every Sunday morning. In an embodiment where the monitor 400 retrieves the on-screen programming 470 at a predetermined time, the display may store the on-screen programming 470 in memory 440. The monitor 400 may also be adapted to display only the on-screen programming 470 which is currently available (for instance, the display will not show programming that was available yesterday).

After the monitor 400 has retrieved and displayed the on-screen programming 470, the user of the monitor 400 may scroll through the on-screen programming 470 using the user interface and control circuitry 450 and select a program, for instance, “60 Minutes”, to view. The monitor 400 may send a signal to the CTSP or the cable provider that “60 Minutes” has been requested. The CTSP, the cable provider, or both working together may then send a signal or signals relaying the requested programming to the monitor 400 which requested it. The antenna 420 receives the programming and sends the data to a converter 430 which converts the data into a form that is useable by the display 410. In another embodiment, the converter 430 may send the data to a memory 440 which will store the program. The memory 440 may store the program in a compressed form or a non-compressed form. The user may be asked whether he would like to watch the program now, or save it for a later time. When the user replies that he would like to view the program, the program is decompressed (if needed) and converted to a form useable by the display 410 (if needed) and sent to the display 410 for viewing.

In another embodiment, the display may further include a digital video recorder (DVR), for instance like those DVR's currently produced by companies such as TiVo. In this embodiment, the user may record programming even when the user will not be present to view it. For instance, if a user knows that the Laker game will start at 6:00, but he will be in a meeting until 6:15, he may want to record the game using the DVR so that he will be able to catch the beginning of the game, and will be able to see the start of the game after he gets out of the meeting.

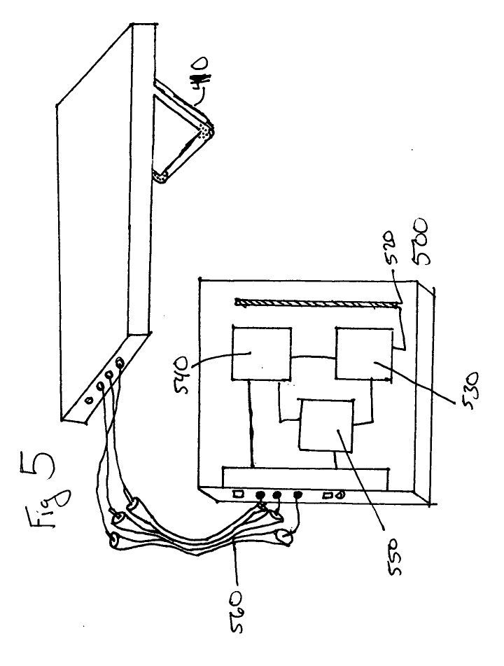

FIG. 5 shows another embodiment of the present invention in which a receiver 500 capable of receiving the cable television programming is adapted to be electrically connected to a display 410. For instance, said receiver 500 may incorporate an antenna 520 to receive cable television programming and on-screen programming 470 at a frequency utilized by cellular telephones and a converter 430 to convert said signals to a form capable of being shown on a display 410 (for instance, said converter 430 may convert the signals to NTSC form or Real Player form, Windows Media Player, etc.). Said receiver 500 may be connected to the display, 410 for instance, an overhead flip-down monitor installed in a vehicle, by RCA plugs 560, coaxial cable, or optical connections for instance. Said receiver 500 may also include a memory 540 for storing said television programming or on-screen programming 470. The receiver 500 may also include a user interface and control circuitry 550 for controlling the various operations of the receiver 500 such as retrieving a program to view, etc.

While the description above refers to a particular embodiment of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the forgoing description, and all changes that come within the meaning and range of equivalency of the claims are therefore intended to be embraced therein.

1. A system for providing cable television comprising:
a cable provider providing television programming; and
a display to display the television programming, wherein the display receives the television programming via radio waves having a frequency at which cellular telephones operate.

2. The system of claim 1, wherein the television programming consists of a plurality of television shows produced by a plurality of program sources.

3. The system of claim 1, wherein the frequency is approximately 1.9 GHz.

4. The system of clam 1, wherein the frequency is approximately 1.8 GHz.

5. The system of claim 1, wherein the display receives the television programming via packet switching technology.

6. The system of claim 1, further including a cellular telephone service provider, wherein the cellular telephone service provider receives the television programming from the cable provider and provides the television programming to the display.

7. The system of claim 6, wherein the cellular telephone service provider receives the television programming from the cable provider via a cable.

8. The system of claim 6, wherein the cellular telephone service provider receives the television programming from the cable provider via a satellite network.

9. The system of claim 6, further including a cellular telephone tower, wherein the cellular telephone tower relays the television programming from the cellular telephone service provider to the display.

10. The system of claim 1 wherein the display is a cellular telephone.

11. The system of claim 1 wherein the display is a monitor located in an automobile.

12. The system of claim 1, wherein the display is a monitor located in a vehicle of public transportation.

13. The system of claim 1, wherein the television programming is electronically compressed before it is provided by the cable provider.

14. The system of 6, wherein the television programming is electronically compressed by the cable provider before it is received by the cellular telephone service provider and the television programming is further compressed by the cellular telephone service provider before the display receives the television programming.

15. The system of claim 14, wherein the television programming is further compressed using MPEG-4.

16. The system of claim 1, wherein the television programming is a single television show.

17. The system of claim 1, wherein the television programming is digital.

18. A Method of providing television programming comprising;
receiving television programming from a plurality of programming sources;
electronically compressing the television programming;
sending the television programming to a display using a frequency on which cellular telephones operate.

19. The method of claim 18, wherein the frequency is approximately 1.9 GHz.

20. The method of claim 18, wherein the frequency is approximately 1.8 GHz.

21. The method of claim 18, wherein the sending the television programming to a display utilizes packet switching technology.

22. The method of claim 18, further including: receiving the television programming by a cellular telephone service provider, wherein the cellular telephone service provider and wherein the cellular telephone service provider performs the sending to the display.

23. The method of claim 18, wherein the cellular telephone service provider receives the television programming from a cable provider via a cable.

24. The method of claim 18, wherein the cellular telephone service provider receives the television programming from a cable provider via a satellite network.

25. An apparatus for receiving a television programming at a frequency used by cellular telephones comprising:
a housing mounted in a vehicle;
a display attached to the housing, said housing adapted to display a cable television program;
an antenna capable of receiving a frequency used by a cellular telephone electrically coupled to the display;

26. The apparatus of claim 25, further including a device for decrypting an encrypted television signal

27. The apparatus of claim 25, further including a device capable of decompressing a compressed video signal.

28. The apparatus of claim 25, wherein the antenna receives signals about 1900 MHz.

29. The apparatus of claim 25, wherein the apparatus receives the television programming as a video stream in real time.

30. The apparatus of claim 25, further including a memory device and wherein the apparatus receives the television programming as a downloadable program which is downloaded to the memory and executed from the memory.
